(19) United States
(12) Patent Application Publication
(10) Pub. No.: US 2020/0391224 A1
(43) Pub. Date: Dec. 17, 2020

(54) REAGENT FOR SEDIMENTARY PHOSPHATE FLOTATION

(71) Applicant: Arr-Maz Products, L.P., Mulberry, FL (US)

(72) Inventors: Yu Xiong, Lakeland, FL (US); Zhengxing Gu, Mulberry, FL (US); Guoxin Wang, Lakeland, FL (US)

(73) Assignee: Arr-Maz Products, L.P., Mulberry, FL (US)

(21) Appl. No.: 16/902,550

(22) Filed: Jun. 16, 2020

Related U.S. Application Data
(60) Provisional application No. 62/862,480, filed on Jun. 17, 2019.

(51) Int. Cl. B03D 1/02; B03D 1/008; B03D 1/012

(52) U.S. Cl. CPC B03D 1/021; B03D 2203/06; B03D 1/012; B03D 1/008

(57) ABSTRACT

A reagent for phosphate flotation, the reagent comprising at least two fatty acids, an alcohol-based surfactant, and chemicals with sulfonate or sulfate groups. The reagent may not comprise fuel oil or diesel. The reagent may increase recovery of phosphate while improving the selectivity, and thus the grade, of the phosphate concentrate.

### CROSS REFERENCE

This application is based on and claims priority to U.S. Provisional Application No. 62/862,480, filed Jun. 17, 2019, which is incorporated herein in its entirety by reference.

### BACKGROUND OF THE INVENTION

### Field of the Invention

This invention relates generally to a process of froth flotation, and more particularly, but not by way of limitation, to a sedimentary phosphate flotation process utilizing a flotation reagent that will convert the traditional two stage flotation process into a single stage process, eliminating the need to use alkaline pH modifiers, pre-saponified fatty acids, and fuel oil with an increase of flotation recovery and better concentrate grade of desired minerals.

### Description of the Related Art

Phosphate rock typically consists of calcium phosphate, largely in the form of apatite, together with clay, quartz, and other non-valuable minerals, and is used in fertilizers and as a source of phosphorus compounds. Froth flotation is the most widely used industrial process for the separation of finely divided minerals in phosphate ores.

The process typically begins by obtaining an appropriately sized flotation feed with a typical grade of 3% to 10% P2O5 through logging, washing, desliming, and sizing. The feed is typically a thick slurry that is traditionally conditioned with a pH modifier, fatty acids (FA), fuel oil (FO), and other co-collectors at a pH of 8.5 to 10.

The most widely used flotation reagents/collectors are unsaturated fatty acids, such as oleic acid, and the technical grades or commercial grades of naturally-occurring fatty acid mixtures having a high proportion of unsaturated fatty acids derived from such oils as tall oil, corn oil, safflower oil, soybean oil, cottonseed oil, and linseed oil; sulfonated fatty acids; animal based fatty acids such as tallow fatty acid and derivatives thereof; as well as synthetic acids. The flotation effect of the fatty acids is usually enhanced by mixing in a certain amount of a petroleum based hydrocarbon, such as diesel oil, #5 fuel oil, or reclaimed oil, which sometimes contains a small amount of a nonionic or anionic emulsifier. The most commonly used pH modifiers for alkaline flotation are caustic soda, soda ash (SA), ammonia, and formulated pH modifiers. Depressant such as sodium silicate and/or causticized starch is sometime used for improving flotation selectivity. The conventional reagent scheme can be simplified as FA/FO+pH Modifier+Depressant or Pre-saponified FA/FO+Depressant. These reagent schemes operate in a pH range of 8.5 to 10.

According to a commonly used process, the incoming mineral feed must be exposed to some means of size fraction control, where clays and oversized fractions are removed, as well as possibly generating different sized flotation feeds. Two flotation processes are often required: the flotation of phosphate with an anionic type collector, followed by a process where the remaining undesired silica minerals are floated away from a phosphate concentrate product with an amine collector to a targeted grade. Some of the most used collectors, such as fatty acids and their derivatives, are thought to be effective collectors for oxidized mineral ores. However, selectivity, and thus the grade of the desired minerals in the concentrates, is a major challenge associated with the recovery of alkaline flotation.

Based on the foregoing, it is desirable to provide a flotation reagent that results in a similar or higher grade concentrate with higher flotation recovery.

It is further desirable for the reagent to effective in a single stage flotation.

It is further desirable for the reagent to be effective at natural pH for conditioning and flotation.

It is further desirable for the reagent to allow the elimination of a pH modifier in the flotation process.

It is further desirable for the reagent to allow the elimination of fuel oil in the flotation process.

It is further desirable for the reagent to allow the elimination of a depressant in the flotation process.

It is further desirable for the reagent to provide improved savings and safety factors compared to currently common flotation processes.

### SUMMARY OF THE INVENTION

In general, in a first aspect, the invention relates to a reagent for phosphate flotation, the reagent comprising at least two fatty acids, an alcohol-based surfactant, and chemicals with sulfonate or sulfate groups. The at least two fatty acids may comprise 50% to 90% by weight of the reagent; the alcohol-based surfactant may comprise 5% to 25% by weight of the reagent; and the chemicals with sulfonate or sulfate groups may comprise 5% to 25% by weight of the reagent. The reagent may not comprise fuel oil or diesel.

The at least two fatty acids may be a mixture of short chain fatty acids and long chain fatty acids. For example, at least two fatty acids may comprise: 1 to 5 wt.-% of saturated C7 hydrocarbon chain; 1 to 3 wt.-% of saturated C9; 10 to 30 wt.-% of saturated C11; 3 to 10 wt.-% of saturated C13; 1 to 5 wt.-% of saturated C15; 0 to 5 wt.-% of monounsaturated C15; 0.5 to 2 wt.-% of bisunsaturated C15; 1 to 3 wt.-% of saturated C17; 5 to 30 wt.-% of monounsaturated C17; 10 to 50 wt.-% of bisunsaturated C17; 0.5 to 5 wt.-% of trisunsaturated C17; 0 to 5 wt.-% of saturated C19; 1 to 5 wt.-% of monounsaturated C19; and 3 to 8 wt.-% of other fatty acids. As another example, the at least two fatty acids may be a mixture of 1.0 to 4 weight parts of long C-chain C18 fatty acids to 1 weight part of short C-chain C12 fatty acids, such as 1 to 4 weight parts of tall oil fatty acid to 1 weight part of coconut oil fatty acid.

The alcohol-based surfactant may comprise a hydrocarbon mixture mainly constituted by normal and iso paraffins of C6. In particular, the alcohol-based surfactant may comprise: 10 to 80 wt.-% of di-2-ethyhexyl ether; 0 to 30 wt.-% of butyl butyrate; 0 to 30 wt-% of 1-butanol; 5 to 30 wt.-% of 2-ehtyl-1,3-hexanediol; 5 to 30 wt.-% of alkyl acetals; 5 to 30 wt.-% of 2-ethylhexanol; 0 to 30 wt.-% of isobutanol; and 0 to 10 wt.-% of isobutyl isobutyrate.

The chemicals with sulfonate or sulfate groups may comprise dodecylbenzene sulfonic acid or salt (DDBSA), sodium dodecyl sulfate (SDS), sodium lauryl sulfate (SLS), sodium coco sulfate (SCS), sodium lauryl ether sulfate, sodium alcohol ether sulfate, potassium salts of those chemicals, or a combination thereof.

In a second aspect, the invention relates to a process of phosphate floatation comprising: pulping phosphate ore with water to about 65% to 75% solids to produce an ore slurry; reagentizing the ore slurry with the reagent described above to produce a reagentized slurry; subjecting the reagentized slurry to flotation to produce an underflow and an overflow; and collecting the overflow as phosphate concentrate. The process may not comprise modifying the pH of the ore slurry or of the reagentized slurry; using a depressant to improve flotation selectivity; or a second flotation step.

### DETAILED DESCRIPTION OF THE INVENTION

The devices and methods discussed herein are merely illustrative of specific manners in which to make and use this invention and are not to be interpreted as limiting in scope.

While the devices and methods have been described with a certain degree of particularity, it is to be noted that many modifications may be made in the details of the construction and the arrangement of the devices and components without departing from the spirit and scope of this disclosure. It is understood that the devices and methods are not limited to the embodiments set forth herein for purposes of exemplification.

In general, in a first aspect, the invention relates to a phosphate flotation reagent that comprises a mixture of at least two fatty acids and at least one alcohol-based surfactant and chemicals with sulfonate or sulfate groups, as well as a process of sedimentary phosphate flotation using the reagent. The process may result in increasing recovery of phosphate while improving the selectivity, and thus the grade, of the phosphate concentrate.

In particular, the reagent may comprise 50% to 90% by weight of the mixture of at least two fatty acids; 5% to 25% by weight of the chemical with sulfonate or sulfate groups; and 5% to 25% by weight of alcohol-based surfactant. The reagent may not comprise fuel oil or diesel.

The reagent may not comprise and may be used in the absence of a pH modifier. Alternately, the reagent may comprise or may be used in conjunction with a pH modifier, which may comprise soda ash, ammonia, caustic, or other formulated pH modifier that is capable of increasing pH of the slurry, or a combination thereof. The reagent may not comprise and may be used in the absence of a depressant. Alternately, the reagent may comprise or may be used in conjunction with a depressant, which may comprise sodium silicate, causticized starch, or other depressant capable of improving flotation selectivity, or a combination thereof.

The mixture of at least two fatty acids may be a mixture of short chain fatty acids and long chain fatty acids. For example, the mixture of at least two fatty acids may comprise: 1 to 5 wt.-% of saturated C7 hydrocarbon chain; 1 to 3 wt.-% of saturated C9; 10 to 30 wt.-% of saturated C11; 3 to 10 wt.-% of saturated C13; 1 to 5 wt.-% of saturated C15; 0 to 5 wt.-% of monounsaturated C15; 0.5 to 2 wt.-% of bisunsaturated C15; 1 to 3 wt.-% of saturated C17; 5 to 30 wt.-% of monounsaturated C17; 10 to 50 wt.-% of bisunsaturated C17; 0.5 to 5 wt.-% of trisunsaturated C17; 0 to 5 wt.-% of saturated C19; 1 to 5 wt.-% of monounsaturated C19; and 3 to 8 wt.-% of other fatty acids. In another example, the mixture of at least two fatty acids may be a mixture of 1.0 to 4 weight parts of long C-chain C18 fatty acids to 1 weight part of short C-chain C12 fatty acids, such as 1 to 4 weight parts of tall oil fatty acid to 1 weight part of coconut oil fatty acid. The at least two fatty acids may conventional fatty acid, modified fatty acid, or a combination thereof.

The chemical with sulfonate or sulfate groups may comprise dodecylbenzene sulfonic acid or salt (DDBSA), sodium dodecyl sulfate (SDS), sodium lauryl sulfate (SLS), sodium coco sulfate (SCS), sodium lauryl ether sulfate, sodium alcohol ether sulfate, potassium salts of those chemicals, or combinations thereof.

The alcohol-based surfactant may comprise a hydrocarbon mixture mainly constituted by normal and iso paraffins of C6. In particular, the alcohol-based surfactant may comprise: 10 to 80 wt.-% of di-2-ethyhexyl ether; 0 to 30 wt.-% of butyl butyrate; 0 to 30 wt-% of 1-butanol; 5 to 30 wt.-% of 2-ehtyl-1,3-hexanediol; 5 to 30 wt.-% of alkyl acetals; 5 to 30 wt.-% of 2-ethylhexanol; 0 to 30 wt.-% of isobutanol; and 0 to 10 wt.-% of isobutyl isobutyrate.

For example, the reagent may combine short chain fatty acids and long chain fatty acids with an alcohol ether sulfate and frother alcohol.

The reagent may be designed for beneficiating sedimentary phosphate ores containing majorly siliceous mineral impurities. The flotation feed may be regular flotation feed prepared by conventional washing and sizing methods.

The ore beneficiation process for separating siliceous impurities from phosphate ore may comprise the steps of: (a) pulping the ore with water to about 65% to 75% solids; (b) reagentizing the ore slurry with collectors with or without pH modification for conditioning; (c) subjecting the reagentized slurry to flotation using the reagent of the present invention; (d) separating the underflow of flotation cell as waste containing major amounts of siliceous impurities; and (e) collecting the overflow as phosphate concentrate.

It is believed that the reagent renders metallurgical advantages for sedimentary phosphate flotation over the conventional reagent schemes of FA/FO under alkaline pH or pre-saponified FA/FO and also eliminate the use of FO in the benefication process for sedimentary phosphate. The use of the reagent may result in similar or higher grade P₂O₅ concentrate with much higher P₂O₅ recovery; single stage flotation instead of the typical two stage process; and elimination of the pH modifier and fuel oil, as well as the possible elimination of depressant, all of which may result in better savings and safety for the industry.

The following examples demonstrate the effectiveness of the reagent. The examples utilize three different flotation feed samples, A, B, and C, collected from different flotation plants. The examples include comparative results of conventional reagent schemes of FA/FO under alkaline pH and pre-saponified FA/FO without pH modification. The examples are given by way of illustration only, and not necessarily by way of limitation.

### EXAMPLE I

Feed sample A (−35+150 mesh) was subjected to flotation with a conventional reagent scheme of FA/DO under alkaline pH and with the reagent of the present invention. To test the conventional reagent scheme, Sample A was conditioned at a slurry density of 70% solids at a predetermined pH of 9.3 with pH modifier, with 0.43 to 0.88 lb oil-base fatty acid per ton feed plus 0.18 to 0.38 lb/t diesel oil (DO). To test the new reagent, Sample A was conditioned for two minutes at a slurry density of 70% solids without pH modification with 0.43 to 0.88 lb/t-feed of the new reagent alone without fuel oil and pH modifier addition. With both reagents, after conditioning, the slurry was diluted to about 30% solids and floated. The underflow of the flotation was discarded as siliceous impurities while the float was collected as concentrate. The flotation results are shown in Table I. Similar concentrate grade with better recovery was achieved with the new reagent scheme as compared to the conventional reagent scheme.

TABLE I

| | FA | DO | pH modifier | | FEED | CONCENTRATION | | TAIL | | Recovery |
|---|---|---|---|---|---|---|---|---|---|---|
| Reagent | lb/t | lb/t | lb/t | pH | BPL % | BPL % | Wt. (%) | BPL % | Wt. (%) | % |
| Conventional | 0.43 | 0.18 | 0.89 | 9.3 | 11.43 | 63.27 | 15.81 | 1.70 | 84.19 | 87.48 |
| Conventional | 0.57 | 0.24 | 1.05 | 9.3 | 11.56 | 61.71 | 17.03 | 1.26 | 82.97 | 90.95 |
| Conventional | 0.88 | 0.38 | 1.22 | 9.3 | 11.60 | 56.16 | 19.18 | 1.03 | 80.82 | 92.83 |
| Novel Reagent | 0.43 | 0.00 | 0.00 | NA | 11.40 | 57.96 | 17.96 | 1.20 | 82.04 | 91.36 |
| Novel Reagent | 0.57 | 0.00 | 0.00 | NA | 11.47 | 56.14 | 18.98 | 1.01 | 81.02 | 92.82 |
| Novel Reagent | 0.88 | 0.00 | 0.00 | NA | 11.44 | 55.50 | 19.41 | 0.83 | 80.59 | 94.15 |

### EXAMPLE II

Feed sample B (−35+150 mesh) was conditioned for two minutes at a slurry density of about 65% solids without pH modification, with 0.86 to 1.71 lb/t-feed pre-saponified fatty acid plus 0.17 to 0.34 lb/t-feed fuel oil (FO) to test the conventional reagent scheme and with 0.26 to 0.51 lb/t-feed of the newly developed reagent alone without FO to test to test the new reagent. After conditioning, the slurry was diluted to about 30% solids and floated. Plant water was used in this example. The underflow of the flotation was discarded as siliceous impurities while the float was collected as concentrate. Again, similar concentrate grade with better recovery was achieved with the new reagent scheme as compared to the conventional reagent scheme

TABLE II

| | FA | FO | FEED | CONCENTRATE | | TAIL | | RECOVERY |
|---|---|---|---|---|---|---|---|---|
| Reagent | lb/t | lb/t | BPL % | BPL % | Wt. (%) | BPL % | Wt. (%) | % |
| Conventional | 0.86 | 0.17 | 10.94 | 53.51 | 16.36 | 2.61 | 83.64 | 80.04 |
| Conventional | 1.15 | 0.23 | 11.21 | 52.90 | 18.24 | 1.91 | 81.76 | 86.07 |
| Conventional | 1.42 | 0.28 | 11.48 | 48.76 | 20.45 | 1.90 | 79.55 | 86.84 |
| Conventional | 1.71 | 0.34 | 11.27 | 50.39 | 19.77 | 1.63 | 80.23 | 88.39 |
| Novel Reagent | 0.26 | 0.0 | 11.63 | 58.43 | 16.23 | 2.56 | 83.77 | 81.55 |
| Novel Reagent | 0.34 | 0.0 | 11.55 | 57.57 | 17.52 | 1.78 | 82.48 | 87.29 |
| Novel Reagent | 0.42 | 0.0 | 11.53 | 53.67 | 19.32 | 1.44 | 80.68 | 89.92 |
| Novel Reagent | 0.51 | 0.0 | 11.50 | 54.05 | 19.24 | 1.36 | 80.76 | 90.45 |

### EXAMPLE III

Feed sample C (−35+150 mesh) was conditioned for two minutes at about 65% solids without pH modification, with 0.82 to 1.63 lb/t-feed pre-saponified fatty acid plus 0.33 to 0.65 lb/t-feed diesel (DO) to test the conventional reagent scheme and 0.82 to 1.63 lb/t-feed of the newly developed reagent alone without DO. After conditioning, the slurry was diluted to about 30% solids and floated. Plant water was used in this example. The underflow of the flotation was discarded as siliceous impurities while the float was collected as concentrate. Again, similar concentrate grade with better recovery was achieved with the new reagent scheme as compared to the conventional reagent scheme.

TABLE III

| | FA | DO | Feed | Concentration | | Tail | | Recovery |
|---|---|---|---|---|---|---|---|---|
| Reagent | lb/t | lb/t | BPL % | BPL % | Wt. (%) | BPL % | Wt. (%) | % |
| Conventional | 0.82 | 0.33 | 34.25 | 2.45 | 51.13 | 4.74 | 48.87 | 93.24 |
| Conventional | 1.23 | 0.49 | 34.12 | 62.43 | 51.70 | 3.82 | 48.30 | 94.59 |
| Conventional | 1.63 | 0.65 | 34.19 | 61.86 | 52.78 | 3.26 | 47.22 | 95.50 |
| Novel Reagent | 0.82 | 0.00 | 34.36 | 61.49 | 54.64 | 1.68 | 45.36 | 97.78 |
| Novel Reagent | 1.23 | 0.00 | 33.70 | 59.80 | 54.21 | 2.80 | 45.79 | 96.20 |
| Novel Reagent | 1.63 | 0.00 | 34.10 | 60.04 | 56.19 | 0.83 | 43.81 | 98.93 |

The flotation results in Examples I, II, and III clearly show that the newly developed novel reagent is much stronger than conventional reagents in the existing flotation process, without the need for FO or DO and possibly with a reduction in reagent. The newly developed novel reagent may significantly improve flotation performance with a potential 50% to 70% reduction on FA dosage while eliminating the need for FO or DO.

Whereas, the devices and methods have been described in relation to the drawings and claims, it should be understood that other and further modifications, apart from those shown or suggested herein, may be made within the spirit and scope of this invention.

What is claimed is:

1. A reagent for phosphate flotation comprising:
at least two fatty acids;
an alcohol-based surfactant; and
chemicals with sulfonate or sulfate groups.

2. The reagent of claim 1 where:
the at least two fatty acids comprise 50% to 90% by weight of the reagent;
the alcohol-based surfactant comprises 5% to 25% by weight of the reagent; and
the chemicals with sulfonate or sulfate groups comprise 5% to 25% by weight of the reagent.

3. The reagent of claim 1 where the reagent does not comprise fuel oil or diesel.

4. The reagent of claim 1 where the at least two fatty acids are a mixture of short chain fatty acids and long chain fatty acids.

5. The reagent of claim 1 where the at least two fatty acids comprise:
1 to 5 wt.-% of saturated C7 hydrocarbon chain;
1 to 3 wt.-% of saturated C9;
10 to 30 wt.-% of saturated C11;
3 to 10 wt.-% of saturated C13;
1 to 5 wt.-% of saturated C15;
0 to 5 wt.-% of monounsaturated C15;
0.5 to 2 wt.-% of bisunsaturated C15;
1 to 3 wt.-% of saturated C17;
5 to 30 wt.-% of monounsaturated C17;
10 to 50 wt.-% of bisunsaturated C17;
0.5 to 5 wt.-% of trisunsaturated C17;
0 to 5 wt.-% of saturated C19;
1 to 5 wt.-% of monounsaturated C19; and
3 to 8 wt.-% of other fatty acids.

6. The reagent of claim 1 where the at least two fatty acids are a mixture of 1.0 to 4 weight parts of long C-chain C18 fatty acids to 1 weight part of short C-chain C12 fatty acids.

7. The reagent of claim 1 where the alcohol-based surfactant comprises a hydrocarbon mixture mainly constituted by normal and iso paraffins of C6.

8. The reagent of claim 1 where the alcohol-based surfactant comprises:
10 to 80 wt.-% of di-2-ethyhexyl ether;
0 to 30 wt.-% of butyl butyrate;
0 to 30 wt-% of 1-butanol;
5 to 30 wt.-% of 2-ehtyl-1,3-hexanediol;
5 to 30 wt.-% of alkyl acetals;
5 to 30 wt.-% of 2-ethylhexanol;
0 to 30 wt.-% of isobutanol; and
0 to 10 wt.-% of isobutyl isobutyrate.

9. The reagent of claim 1 where the chemicals with sulfonate or sulfate groups comprise dodecylbenzene sulfonic acid or salt (DDBSA), sodium dodecyl sulfate (SDS), sodium lauryl sulfate (SLS), sodium coco sulfate (SCS), sodium lauryl ether sulfate, sodium alcohol ether sulfate, potassium salts of those chemicals, or a combination thereof.

10. A process of phosphate floatation comprising:
pulping phosphate ore with water to about 65% to 75% solids to produce an ore slurry;
reagentizing the ore slurry with a reagent to produce a reagentized slurry, where the reagent comprises a mixture of at least two fatty acids, an alcohol-based surfactant, and chemicals with sulfonate or sulfate groups;
subjecting the reagentized slurry to flotation to produce an underflow and an overflow; and
collecting the overflow as phosphate concentrate.

11. The process of claim 10 where the process does not comprise modifying the pH of the ore slurry or of the reagentized slurry.

12. The process of claim 10 where the process does not comprise using a depressant to improve flotation selectivity.

13. The process of claim 10 where the process does not comprise a second flotation step.

14. The process of claim 10 where:
the at least two fatty acids comprise 50% to 90% by weight of the reagent;
the alcohol-based surfactant comprises 5% to 25% by weight of the reagent; and
the chemicals with sulfonate or sulfate groups comprise 5% to 25% by weight of the reagent

15. The process of claim 10 where the reagent does not comprise fuel oil or diesel.

16. The process of claim 10 where the at least two fatty acids comprise:
1 to 5 wt.-% of saturated C7 hydrocarbon chain;
1 to 3 wt.-% of saturated C9;
10 to 30 wt.-% of saturated C11;
3 to 10 wt.-% of saturated C13;
1 to 5 wt.-% of saturated C15;
0 to 5 wt.-% of monounsaturated C15;
0.5 to 2 wt.-% of bisunsaturated C15;
1 to 3 wt.-% of saturated C17;
5 to 30 wt.-% of monounsaturated C17;
10 to 50 wt.-% of bisunsaturated C17;
0.5 to 5 wt.-% of trisunsaturated C17;
0 to 5 wt.-% of saturated C19;
1 to 5 wt.-% of monounsaturated C19; and
3 to 8 wt.-% of other fatty acids.

17. The process of claim 10 where the at least two fatty acids are a mixture of 1.0 to 4 weight parts of long C-chain C18 fatty acids to 1 weight part of short C-chain C12 fatty acids.

18. The process of claim 10 where the alcohol-based surfactant comprises a hydrocarbon mixture mainly constituted by normal and iso paraffins of C6.

19. The process of claim 10 where the alcohol-based surfactant comprises:
10 to 80 wt.-% of di-2-ethyhexyl ether;
0 to 30 wt.-% of butyl butyrate;
0 to 30 wt-% of 1-butanol;
5 to 30 wt.-% of 2-ehtyl-1,3-hexanediol;
5 to 30 wt.-% of alkyl acetals;
5 to 30 wt.-% of 2-ethylhexanol;
0 to 30 wt.-% of isobutanol; and
0 to 10 wt.-% of isobutyl isobutyrate.

20. The process of claim 10 where the chemicals with sulfonate or sulfate groups comprise dodecylbenzene sulfonic acid or salt (DDBSA), sodium dodecyl sulfate (SDS), sodium lauryl sulfate (SLS), sodium coco sulfate (SCS), sodium lauryl ether sulfate, sodium alcohol ether sulfate, potassium salts of those chemicals, or a combination thereof.
